(19) United States
(12) Patent Application Publication
(10) Pub. No.: US 2021/0245071 A1
(43) Pub. Date: Aug. 12, 2021

(54) UNMANNED AIR VEHICLE RACING SYSTEM AND METHOD

(71) Applicant: Minkyung PARK, Hwaseong-si (KR)

(72) Inventor: Minkyung PARK, Hwaseong-si (KR)

(21) Appl. No.: 16/322,481

(22) PCT Filed: Dec. 13, 2018
(86) PCT No.: PCT/KR2018/015864

§ 371 Date: Jan. 31, 2019

(30) Foreign Application Priority Data
Jan. 11, 2018 (KR) 10-2018-0004058

(51) Int. Cl. A63K 3/00; B64C 39/02; A63F 9/14

(52) U.S. Cl. CPC A63K 3/00; B64C 2201/12; A63F 9/143; B64C 39/024

(57) ABSTRACT

The present invention relates to an unmanned air vehicle racing system and method. The unmanned air vehicle racing system includes: at least one unmanned air vehicle which transmits data on an image to a server; a track which includes: a plurality of obstacles which detects time information, speed information, direction information, and altitude information, and which transmits data on the detected information to the server; and a plurality of guide bars which is located among the obstacles, and which indicates traveling directions; the server which processes the data received from the unmanned air vehicle, and which calculates the score of the unmanned air vehicle based on the data, received from the plurality of obstacles, according to a set algorithm; and an electronic scoreboard which receives the processed data and the calculated score from the server, and which displays a 2D or 3D image and score and ranking information.

### TECHNICAL FIELD

The present invention relates to an unmanned air vehicle racing system and method, and more specifically to an unmanned air vehicle racing system and method in which sensors are provided on the obstacles of a track so that a score may be calculated and displayed on an electronic scoreboard whenever an unmanned air vehicle passes through each of the obstacles, thereby improving the ability of a user to control the unmanned air vehicle and also satisfying the interest of race spectators.

### BACKGROUND ART

Unmanned air vehicles, which first appeared for military purposes in early 2000, have been widely used not only in inventory management and distribution systems but also in sports relay broadcasting, various types of movie or drama shooting, etc., which are difficult for humans to directly perform, due to the gradual development of manufacturing technology. Furthermore, there is a tendency for the use of unmanned air vehicles to extend from commercial purposes to non-commercial purposes, such as purposes for personal hobbies.

However, conventionally, when an individual intends to use an unmanned air vehicle, there is no sufficient space to freely fly the unmanned air vehicle due to a problem regarding an aviation law issue for unmanned air vehicles or a limitation to the flight altitude of unmanned air vehicles. In unmanned air vehicle contests, there is a limitation in attracting the interest of users because unmanned air vehicles simply pass through poles or only the flight speeds of unmanned air vehicles are emphasized.

Therefore, there is an urgent need for the development of an unmanned air vehicle racing system that enables the user of an unmanned air vehicle to continuously have interest in controlling the unmanned air vehicle and also enables third persons to have visual satisfaction in viewing an unmanned air vehicle race.

### DISCLOSURE

### Technical Problem

An object of the present invention is to provide an unmanned air vehicle racing system and method by which various obstacles are disposed on a track so that the ability of a user to control an unmanned air vehicle may be tested and the speed, obstacle passage result and race ranking of the unmanned air vehicle may be displayed on an electronic scoreboard in real time, thereby attracting the interest of race spectators.

Another object of the present invention is to provide an unmanned air vehicle racing system and method by which a track is configured in the form of a variable track so that the locations of obstacles and guide bars included in the track user may be varied according to the setting of a user, thereby satisfying the interest of the user.

Still another object of the present invention is to provide an unmanned air vehicle racing system and method by which when an unmanned air vehicle passes through an obstacle, not only a result regarding whether the unmanned air vehicle has passed through the obstacle but also a fact regarding whether the race is being performed by considering a direction and an altitude with respect to an obstacle through which will be passed subsequently are taken into account, and thus the interest of a user operating the unmanned air vehicle may be attracted and the score of the unmanned air vehicle may be more accurately calculated.

The objects of the present invention are not limited to the above-described objects, and other objects that have not been described above will be clearly understood by those skilled in the art from the following description.

### Technical Solution

In order to accomplish the above objects, according to an embodiment of the present invention, there is provided an unmanned air vehicle racing system, including: at least one unmanned air vehicle which transmits data on a taken image to a server; a track which includes: a plurality of obstacles which detects time information, speed information, direction information, and altitude information when the unmanned air vehicle passes through the obstacles, and which transmits data on the detected information to the server; and a plurality of guide bars which is located among the plurality of obstacles, and which indicates the traveling directions of the unmanned air vehicle; the server which processes the data received from the unmanned air vehicle, and which calculates the score of the unmanned air vehicle participating in a race based on the data, received from the plurality of obstacles, according to a set algorithm; and an electronic scoreboard which receives the processed data and data on the calculated score from the server, and which displays a 2D or 3D image taken by the unmanned air vehicle and the score information and ranking information of the unmanned air vehicle.

According to another feature of the present invention, the track is a variable track in which the shape in which the plurality of obstacles and the plurality of guide bars are arranged is varied into a set shape.

According to still another feature of the present invention, each of the obstacles includes: a gate in which an entrance having a set shape through which the unmanned air vehicle can pass is formed; a sensor unit which is provided in a set location, and which detects time information, speed information, direction information, and altitude information when the unmanned air vehicle passes through the gate; a communication unit which transmits data on the information, detected by the sensor unit, to the server; and a control unit which controls overall operation.

According to still another feature of the present invention, the server includes: a control unit which processes the data received from the unmanned air vehicle, and which calculates the score of the unmanned air vehicle participating in the race based on the data, received from the plurality of obstacles, according to the set algorithm; and a communication unit which receives data on the taken image from the unmanned air vehicle, which transmits the processed data to the electronic scoreboard, which receives the data on the detected information from the obstacles, and which transmits the data on the calculated score to the electronic scoreboard.

In order to accomplish the above objects, according to an embodiment of the present invention, there is provided an unmanned air vehicle racing method, including: transmitting, at an unmanned air vehicle, data on a taken image to a server; detecting, at the plurality of obstacles of a track, time information, speed information, direction information, and altitude information when the unmanned air vehicle passes through the obstacles, and transmitting, at the plurality of obstacles of the track, data on the detected information to the server; being located, at the plurality of guide bars of the track, among the plurality of obstacles, and indicating, at the plurality of guide bars of the track, the traveling directions of the unmanned air vehicle; processing, at the server, the data received from the unmanned air vehicle, and calculating, at the server, the score of the unmanned air vehicle participating in a race based on the data, received from the plurality of obstacles, according to a set algorithm; and receiving, at an electronic scoreboard, the processed data and data on the calculated score from the server, and displaying, at the electronic scoreboard, a 2D or 3D image taken by the unmanned air vehicle and the score information and ranking information of the unmanned air vehicle.

### Advantageous Effects

The present invention may provide the unmanned air vehicle racing system and method by which various obstacles are disposed on a track so that the ability of a user to control the unmanned air vehicle may be tested and the speed, obstacle passage result and race ranking of the unmanned air vehicle may be displayed on an electronic scoreboard in real time, thereby attracting the interest of race spectators.

The present invention may provide the unmanned air vehicle racing system and method by which the track is configured in the form of a variable track so that the locations of the obstacles and the guide bars included in the track may be varied according to the setting of a user, thereby satisfying the interest of the user.

The present invention may provide the unmanned air vehicle racing system and method by which when the unmanned air vehicle passes through an obstacle, not only a result regarding whether the unmanned air vehicle has passed through the obstacle but also a fact regarding whether the race is being performed by considering a direction and an altitude with respect to an obstacle through which will be passed subsequently are taken into account, and thus the interest of a user operating the unmanned air vehicle may be attracted and the score of the unmanned air vehicle may be more accurately calculated.

The effects according to the present invention are not limited to the above-described items, and more various effects are included in the present specification.

### DESCRIPTION OF DRAWINGS

FIG. 1 is a view showing the overall configuration of an unmanned air vehicle racing system according to an embodiment of the present invention;

FIG. 2 is a block diagram schematically showing the configuration of an unmanned air vehicle according to an embodiment of the present invention;

FIG. 3 is a view schematically showing the configuration of an obstacle according to an embodiment of the present invention;

FIGS. 4a to 4c are a block diagram schematically showing the configuration of a server according to an embodiment of the present invention, a block diagram schematically showing the configuration of the control unit of a server according to an embodiment of the present invention, and a view illustrating a set algorithm according to an embodiment of the present invention, respectively;

FIG. 5a is a view showing the configuration of a track according to an embodiment of the present invention, and FIGS. 5b to 5f are views illustrating obstacles included in a track according to an embodiment of the present invention;

FIG. 6 is a view illustrating an image displayed on an electronic scoreboard according to an embodiment of the present invention; and

FIG. 7 is a flowchart illustrating an unmanned air vehicle racing method according to an embodiment of the present invention.

### MODE FOR INVENTION

The advantages and features of the present invention and methods for achieving the advantages and the features will be will be apparent from embodiments that will be described in detail below in conjunction with the accompanying drawings. However, the present invention is not limited to the embodiments disclosed below, but may be implemented in different various forms. The present embodiments are provided to make the disclosure of the present invention complete and to fully convey the scope of the present invention to those having ordinary knowledge in the art to the present invention pertains. The present invention is defined by the scope of the attached claims.

The combinations of blocks of the attached block diagrams and steps of the attached flowcharts may be implemented by algorithms or computer program instructions including firmware, software, or hardware. These algorithms or computer program instructions may be installed on a processor of a general purpose computer, a special purpose computer, or another programmable data processing device, and thus the instructions that are executed via the processor of the computer or programmable data processing device form a means for implementing the functions specified in the blocks of the block diagrams or the steps of the flowcharts. These algorithms or computer program instructions may also be stored in a computer-usable or computer-readable memory that can direct a computer or another programmable data processing device to function in a particular manner, and thus the instructions that are stored in the computer-usable or computer-readable memory produce an article of manufacture including an instruction means that implements the functions specified in the blocks of the block diagrams or steps of the flowcharts. The computer program instructions may also be loaded into a computer or another programmable data processing device to cause a series of operational steps to be performed in the computer or programmable data processing device to realize a computer-implemented process, and thus the instructions that are executed on the computer or programmable data processing device provide steps for implementing the functions specified in the blocks of the block diagrams or steps of the flowcharts.

Furthermore, each block or each step may represent a module, segment, or portion of code that includes one or more executable instructions for implementing the specified logical function(s). It should also be noted that in some alternative implementations, the functions noted in the blocks or steps may occur in a different order. For example, two blocks or steps shown in succession may, in fact, be executed substantially concurrently or the blocks or steps may sometimes be executed in reverse order, depending upon the functionality involved.

Throughout the specification, the same reference symbols designate the same components.

Features of various embodiments of the present invention may be partially or totally coupled to or combined with each other. As will be clearly appreciated by those skilled in the art, technically various interactions and operations are possible. Various embodiments may be practiced individually or in combination.

Various embodiments of the present invention will be described in detail below with reference to the accompanying drawings.

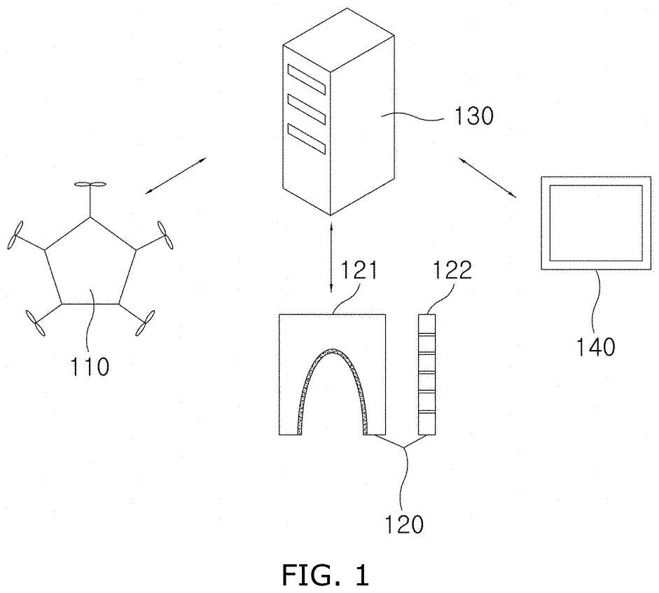

FIG. 1 is a view showing the overall configuration of an unmanned air vehicle racing system according to an embodiment of the present invention. First, as shown in FIG. 1, the unmanned air vehicle racing system according to the embodiment of the present invention includes an unmanned air vehicle 110, a track 120, a server 130, and an electronic scoreboard 140.

The unmanned air vehicle 110 is a flight vehicle that autonomously flies by recognizing and determining a surrounding environment by means of a previously input program and the unmanned air vehicle 110 itself without a pilot. For example, the unmanned air vehicle 110 may include a drone, or the like.

First, the unmanned air vehicle 110 takes images in a set direction by means of a camera mounted on the unmanned air vehicle 110 or the like. For example, the unmanned air vehicle 110 may take images of a front surface, a rear surface, a left surface, a right surface, and omnidirectional surfaces (360 degrees) with respect to the unmanned air vehicle 110 while passing through an obstacle.

Thereafter, the unmanned air vehicle 110 transmits data on the taken images to the server 130 in real time.

The track 120 includes a plurality of obstacles 121 and a plurality of guide bars 122. In this case, each of the obstacles 121 refers to an object that is disposed on the track 120 and passed through by the unmanned air vehicle 110 during a racing process, and each of the guide bars 122 refers to an object that is located between the plurality of obstacles 121 within the track 120 and indicates a traveling direction of the unmanned air vehicle 110.

In this case, the track 120 is a variable track in which the arrangement of the plurality of obstacles 121 and the plurality of guide bars 122 may be varied according to the setting of a user. For example, in the track 120, the locations at which the obstacles 121 and the guide bars 122 are arranged may be varied into a circular shape, an 8 shape, an S shape, a maze shape, or the like according to the setting of a user.

Each of the obstacles 121 detects time information, speed information, direction information, and altitude information when the unmanned air vehicle 110 passes through the obstacle 121, and transmits data on the detected information to the server 130. More specifically, the obstacle 121 detects time information, speed information, direction information, and altitude information when the unmanned air vehicle 110 passes through the obstacle 121, and transmits data on the detected time information, speed information, direction information, and altitude information to the server 130.

The server 130 processes the data received from the unmanned air vehicle 110, and transmits the processed data to the electronic scoreboard 140. More specifically, the server 130 processes data about a taken 2D image, received from the unmanned air vehicle 110, into a 3D image.

Thereafter, the server 130 transmits data on the 2D image, taken by the unmanned air vehicle 110, and data on the 3D image, obtained by processing the 2D image in the server 130, to the electronic scoreboard 140.

Furthermore, the server 130 receives data on time information, speed information, direction information, and altitude information when the unmanned air vehicle 110 has passed from the obstacles 121, and calculates the score of the unmanned air vehicle 110, participating in the race, based on the received data according to a set algorithm.

Thereafter, the server 130 transmits data on the score information and ranking information of the unmanned air vehicle 110 to the electronic scoreboard 140.

The electronic scoreboard 140 displays the image, taken by the unmanned air vehicle 110 participating in the race, in the form of a 2D or 3D image. More specifically, the electronic scoreboard 140 may receive the processed data from the server 130, and may display the processed data in a set region of the electronic scoreboard 14 in the form of a 2D or 3D image according to the setting of a user.

Furthermore, the electronic scoreboard 140 displays the score information and ranking information of the unmanned air vehicle 110 participating in the race in a set region. More specifically, the electronic scoreboard 140 receives data on the calculated score from the server 130, and then displays the score information and ranking information of the unmanned air vehicle 110 participating in the race in the set region.

The unmanned air vehicle racing system according to the embodiment of the present invention is configured such that various obstacles 121 may be disposed on the track 120 and then the ability of a user to control the unmanned air vehicle 110 may be tested and such that the speed, obstacle passage result and race ranking of the unmanned air vehicle 110 may be displayed on the electronic scoreboard 140 in real time, and thus the unmanned air vehicle racing system has the advantage of attracting the interest of a user.

Furthermore, the unmanned air vehicle racing system according to the embodiment of the present invention is configured such that the track 120 may be configured in the form of a variable track so that the locations of the obstacles 121 and the guide bars 122 included in the track 120 may be varied according to the setting of a user, and thus the unmanned air vehicle racing system has the advantage of improving economic efficiency and also improving the degree of satisfaction of the user.

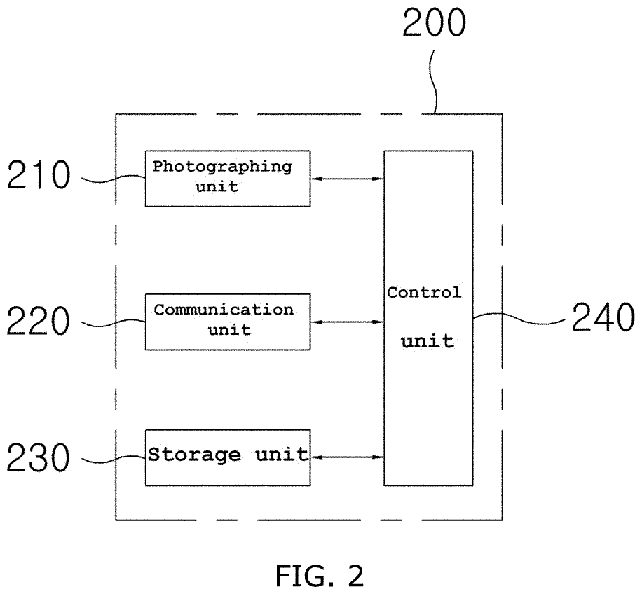

FIG. 2 is a block diagram schematically showing the configuration of an unmanned air vehicle according to an embodiment of the present invention. First, as shown in FIG. 2, the unmanned air vehicle 200 according to the embodiment of the present invention includes a photographing unit 210, a communication unit 220, a storage unit 230, and a control unit 240.

The photographing unit 210 takes a moving image and a photo in a set direction according to the setting of a user. For example, the photographing unit 210 may take images of a front surface, a rear surface, a left surface, a right surface, and omnidirectional surfaces with respect to the unmanned air vehicle while passing through each of the plurality of obstacles disposed along the track.

The communication unit 220 enables communication with a portable terminal, a computer, a server, or another unmanned air vehicle. More specifically, the communication unit 220 transmits data on the images, taken by the unmanned air vehicle, to the server.

Furthermore, the communication unit 230 receives manipulation information including the speed, direction, and altitude information of the unmanned air vehicle from a terminal.

The storage unit 230 stores various types of information under the control of the control unit 240. More specifically, the storage unit 230 stores the image information, taken by the photographing unit 210, and various types of information under the control of the control unit 240.

The control unit 240 performs various functions for the unmanned air vehicle by executing various software programs, and also performs processing and control for voice communication and data communication.

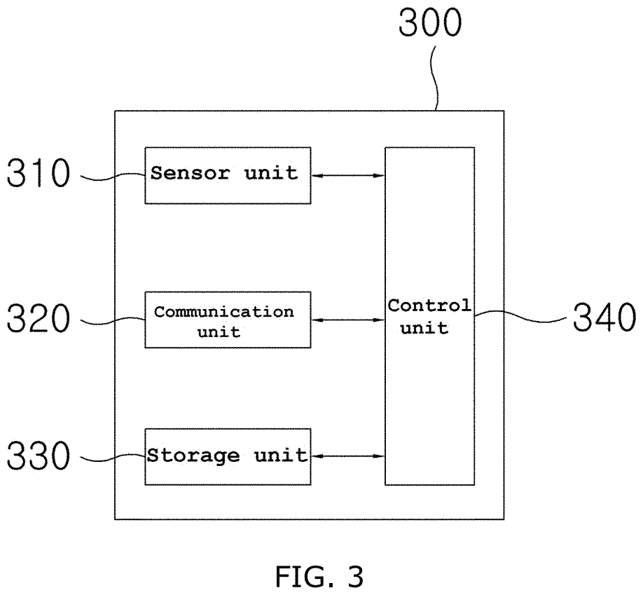

FIG. 3 is a view schematically showing the configuration of an obstacle according to an embodiment of the present invention. First, as shown in FIG. 3, the obstacle 300 according to the embodiment of the present invention includes a sensor unit 310, a communication unit 320, a storage unit 330, and a control unit 340.

The sensor unit 310 is provided at a set location of the obstacle 300, and detects the time information, speed information, direction information, and altitude information of the unmanned air vehicle that passes through the gate of the obstacle 300. In this case, the gate refers to an entrance having a set shape through which the unmanned air vehicle may pass. For example, the gate may be formed in a set region of the obstacle 300 in one of various shapes, such as an arcuate shape, a hexagonal shape, a triangular shape, a rectangular shape, etc.

The communication unit 320 is provided in a set region of the obstacle 300, and transmits data on the information, detected by the sensor unit 310, to the server. More specifically, the communication unit 320 transmits data on the time information, speed information, direction information, and altitude information of the unmanned air vehicle having passed through the obstacle 300, which is detected by the sensor unit 310, to the server.

The storage unit 330 stores various types of information under the control of the control unit 340. For example, the storage unit 330 stores various types of information regarding passage through the obstacle 300 that is detected by the sensor unit 310.

The control unit 340 performs various functions for the obstacle 300, and also performs processing and control for voice communication and data communication.

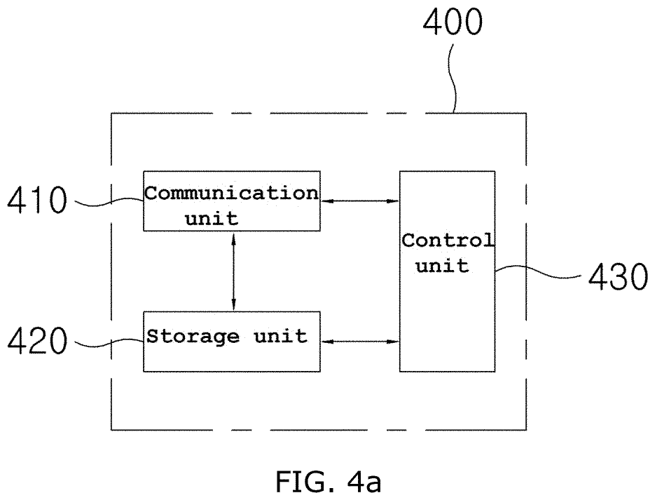

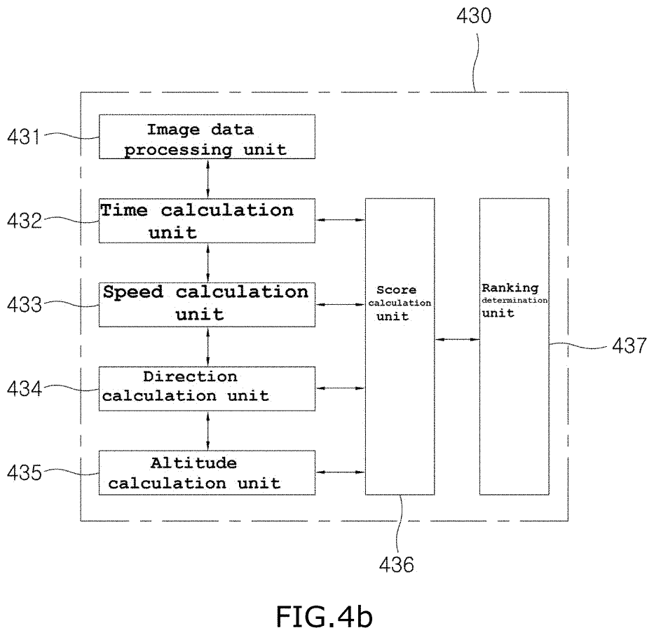

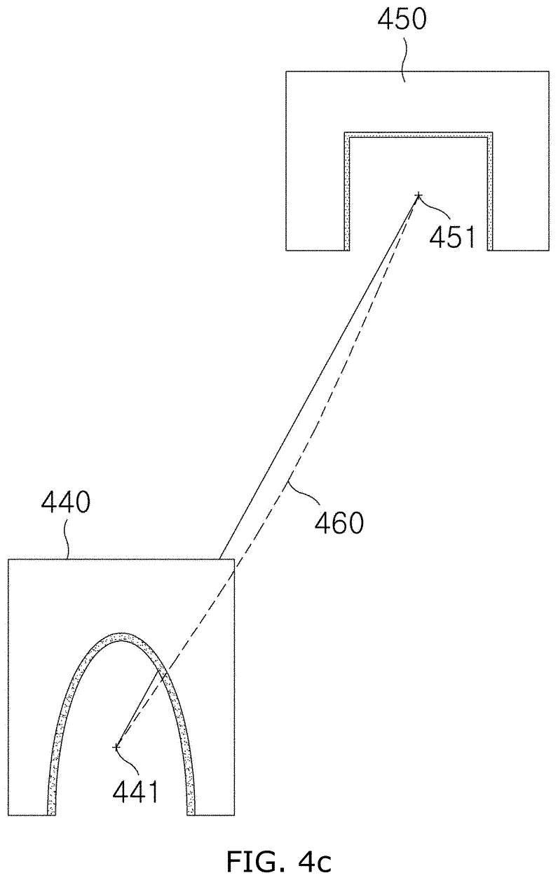

FIGS. 4a to 4c are a block diagram schematically showing the configuration of a server according to an embodiment of the present invention, a block diagram schematically showing the configuration of the control unit of a server according to an embodiment of the present invention, and a view illustrating a set algorithm according to an embodiment of the present invention, respectively. First, FIG. 4a is a block diagram schematically showing the configuration of a server according to an embodiment of the present invention. As shown in FIG. 4a, the server 400 according to the embodiment of the present invention includes a communication unit 410, a storage unit 420, and a control unit 430.

The communication unit 410 enables communication with a portable terminal, a computer, an unmanned air vehicle, or another server. More specifically, the communication unit 410 receives data on an image, taken by the unmanned air vehicle, from the unmanned air vehicle, and transmits processed data to the electronic scoreboard after the control unit 430 has processed the data. Furthermore, the communication unit 410 receives information, detected by the obstacle, from the obstacle, and transmits data on a calculated score to the electronic scoreboard after the control unit 430 has calculated the score.

The storage unit 420 stores various types of information under the control of the control unit 430. More specifically, the storage unit 420 stores data on an image, received by the communication unit 410, and data on information, detected by the obstacle, under the control of the control unit 430.

The control unit 430 performs various functions for the server 400 by executing various software programs, and also performs processing and control for voice communication and data communication. More specifically, the control unit 430 processes data received from the unmanned air vehicle, and calculates the score of the unmanned air vehicle participating in a race based on data, received from the plurality of obstacles, according to a set algorithm.

FIG. 4b is a block diagram schematically showing the configuration of the control unit of a server according to an embodiment of the present invention, and FIG. 4c is a view illustrating a set algorithm according to an embodiment of the present invention. For ease of description, FIGS. 4b and 4c will be described together below.

First, as shown in FIG. 4b, the control unit 430 of the server according to the embodiment of the present invention includes an image data processing unit 431, a time calculation unit 432, a speed calculation unit 433, a direction calculation unit 434, an altitude calculation unit 435, a score calculation unit 436, and a ranking determination unit 437.

The image data processing unit 431 processes a taken 2D image, received from a plurality of unmanned air vehicles, into a 3D image.

The time calculation unit 432 calculates the racing time of the unmanned air vehicle having passed through the obstacles by using the time information of the unmanned air vehicle detected by the obstacles. For example, the time calculation unit 432 may calculate the overall racing time of the unmanned air vehicle by calculating the time that is taken by the unmanned air vehicle participating in a race to move from a starting obstacle 440 to a destination obstacle 450.

As another example, the time calculation unit 432 may calculate lap time between obstacle A 440 and obstacle B 450 by calculating the time at which the unmanned air vehicle passes through the obstacle A 440 and the time at which the unmanned air vehicle passes through the obstacle B 450, respectively.

The speed calculation unit 433 calculates the racing speed of the unmanned air vehicle having passed through the obstacles by using the speed information of the unmanned air vehicle detected by the obstacles. For example, the speed calculation unit 433 may calculate the speed at which the unmanned air vehicle passes through the obstacle A 440 and the speed at which the unmanned air vehicle passes through the obstacle B 450.

The direction calculation unit 433 calculates the racing direction of the unmanned air vehicle having passed through the obstacles by using the direction information of the unmanned air vehicle detected by the obstacles. More specifically, the direction calculation unit 433 may calculate the degree at which the unmanned air vehicle is tilted to the left or right while passing through each of the obstacles. For example, the direction calculation unit 433 may calculate the degree at which the unmanned air vehicle is tilted to the left or right with respect to each of the centers 441 and 451 of gates provided on respective set locations of the obstacle A 440 and the obstacle B 450 while passing through the obstacle A 440 or obstacle B 450.

The altitude calculation unit 435 calculates the racing altitude of the unmanned air vehicle having passed through each of the obstacles by using the altitude information of the unmanned air vehicle detected by each of the obstacles. More specifically, the altitude calculation unit 435 may calculate the altitude at which the unmanned air vehicle moves with respect to an upward or downward direction while passing through each of the obstacles. For example, the altitude calculation unit 435 may calculate the distance by which the unmanned air vehicle is spaced apart from each of the centers 441 and 451 of the gates provided at the respective set locations of the obstacle A 440 and the obstacle B 450 while passing through the obstacle A 440 or obstacle B 450.

The score calculation unit 436 calculates the score of the unmanned air vehicle participating in the race based on data, received from the plurality of obstacles, according to the set algorithm. More specifically, the score calculation unit 436 calculates the score of the unmanned air vehicle participating in the race based on the information calculated by the time calculation unit 432, the speed calculation unit 433, the direction calculation unit 434, and the altitude calculation unit 435.

An example in which the score calculation unit 436 calculates the score of an unmanned air vehicle when unmanned air vehicle C successively passes through obstacle A 440 and obstacle B 450 will be described below.

In the above-described example, when the unmanned air vehicle passes through the obstacle A 440, the score calculation unit 436 may acquire the racing direction and altitude information of the unmanned air vehicle when the unmanned air vehicle passes through the obstacle A 440 from the direction calculation unit 434 and the altitude calculation unit 435.

Thereafter, the score calculation unit 436 may connect the center 441 of the gate of the obstacle A 440, which has been passed through by the unmanned air vehicle, and the center 451 of the gate of the obstacle B 450, which will be subsequently passed through, with an imaginary rectilinear line 460, and may calculate the score of passage through the obstacle A 440 based on results regarding the direction and the altitude in and at which the unmanned air vehicle has passed through the center 441 of the gate of the obstacle A 440 with respect to the imaginary rectilinear line 460.

In other words, in an embodiment of the present invention, the set algorithm is an algorithm that connects the center of the gate of an obstacle, which has been passed through by the unmanned air vehicle, and the center of the gate of an obstacle, which will be subsequently passed through, with the imaginary rectilinear line 460 and calculates the score of passage through the obstacle 440 based on results regarding the direction and the altitude in and at which the unmanned air vehicle has passed through the center of the gate of the obstacle A 440 with respect to the imaginary rectilinear line 460.

The ranking determination unit 437 determines the ranking of the unmanned air vehicle participating in the race based on the score calculated by the score calculation unit 436.

In an embodiment of the present invention, when the unmanned air vehicle passes through an obstacle, not only a result regarding whether the unmanned air vehicle has passed through the obstacle but also a fact regarding whether the race is being performed by considering a direction and an altitude with respect to an obstacle through which will be passed subsequently are taken into account, and thus advantages arise in that the interest of a user operating the unmanned air vehicle may be attracted and the score of the unmanned air vehicle may be more accurately calculated.

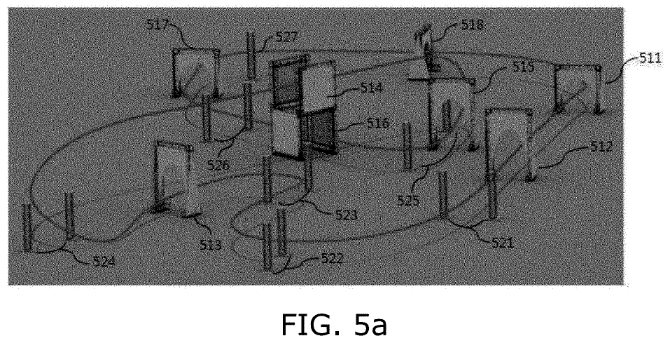

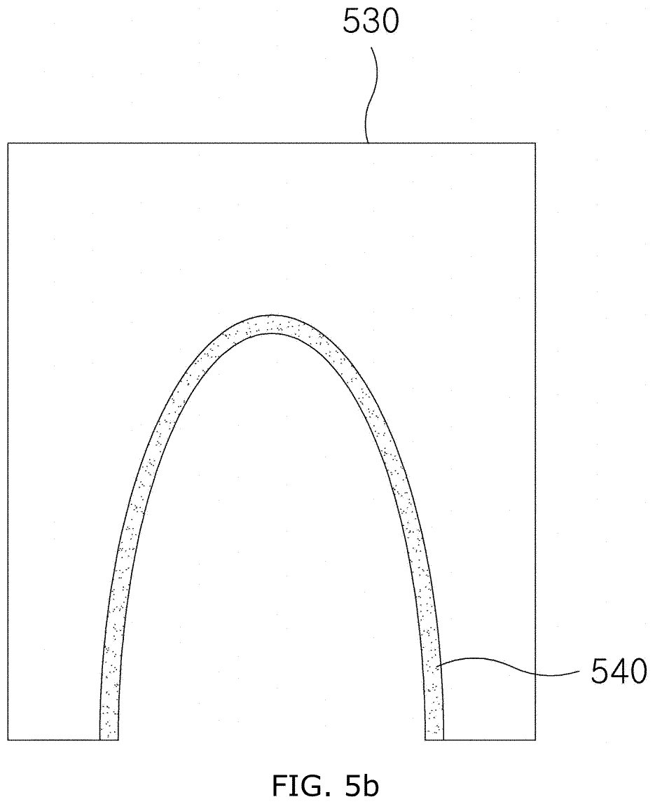

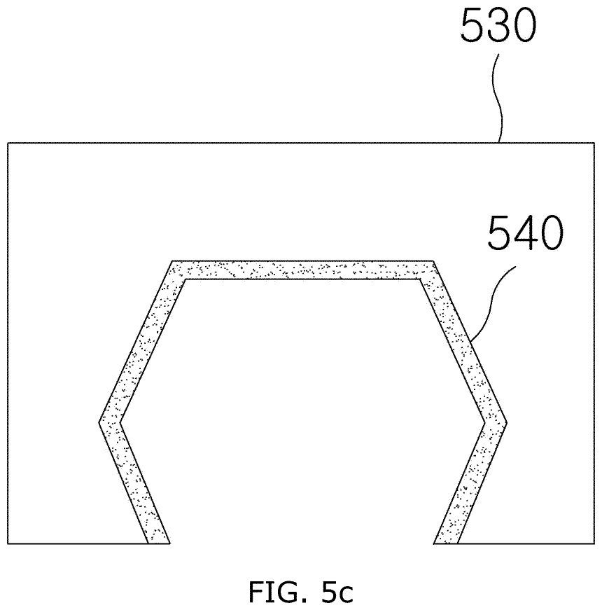

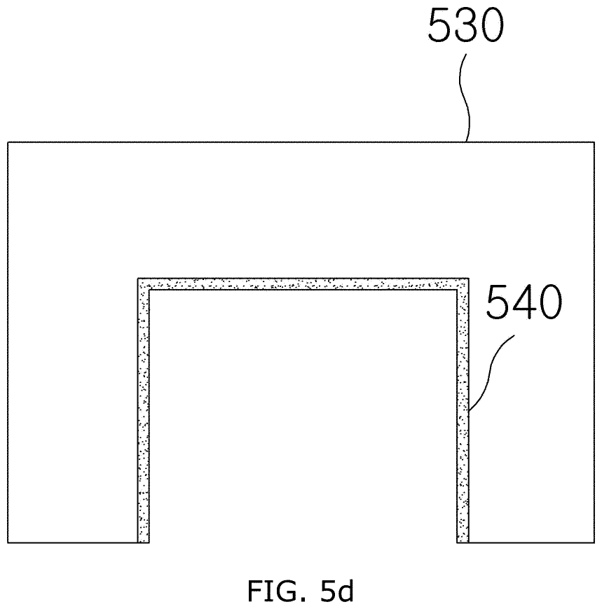

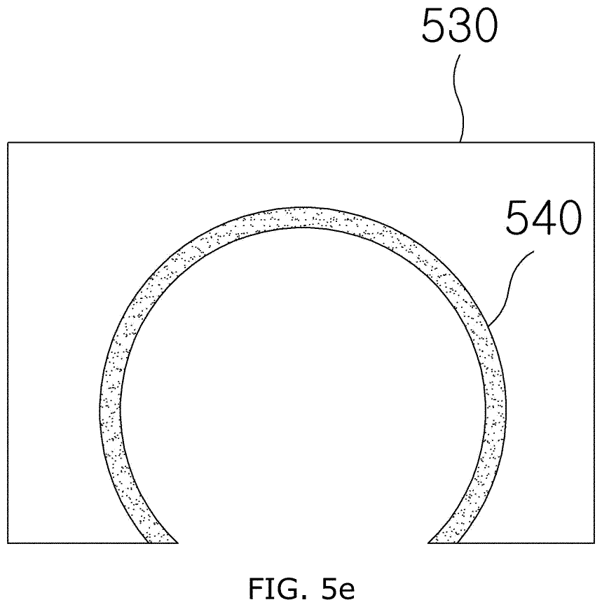

FIG. 5a is a view showing the configuration of a track according to an embodiment of the present invention, and FIGS. 5b to 5f are views illustrating obstacles included in a track according to an embodiment of the present invention. First, as shown in FIG. 5a, the track according to the embodiment of the present invention includes a plurality of obstacles 511 to 518 and a plurality of guide bars 521 to 527.

There will be described an embodiment in which an unmanned air vehicle races along the track below. First, the unmanned air vehicle starts from a starting point (a starting obstacle) 511, sequentially passes through subsequent obstacles 512 to 517, and arrives at a destination point (a destination obstacle) 518, thereby terminating the race.

Although an example in which the single unmanned air vehicle races along the track has been described for ease of description in the embodiment of the present invention, it will be apparent that a plurality of unmanned air vehicles may race with one another along a track.

In this case, the starting gate 511 from which the unmanned air vehicle starts may provide notification of the start of a race by being opened as in the track of a horse racing park.

Furthermore, in this case, the plurality of guide bars 521 to 527 each configured to indicate the traveling direction of the unmanned air vehicle may be provided among the obstacles. Although the guide bars 521 to 527 may be provided among the obstacle, the guide bars 521 to 527 may not be provided according to the setting of a user.

The plurality of guide bars 521 to 527 may function not only to guide the unmanned air vehicle through the race but also to satisfy the sights of spectators who watch the race. Furthermore, although the plurality of guide bars 521 to 527 is intended to guide the unmanned air vehicle through the race, they may collide with the unmanned air vehicle during the race. Accordingly, the guide bars 521 may be made of the combination of hard material and also soft material.

In this case, the track is a variable track in which the shape in which the plurality of obstacles 511 to 518 and the plurality of guide bars 521 to 527 are arranged may be varied according to the setting of a user. More specifically, the track may be varied like train rails. For example, the track is a variable track in which the shape in which the plurality of obstacles 511 to 518 and the plurality of guide bars 521 to 527 are arranged may be varied by using a motor.

Furthermore, the track is made of a flexible LED obtained by combining soft material and hard material. For example, the track may be made by surrounding PVC with silicon and epoxy or resin.

Furthermore, the track is a variable track that may be used not only in an indoor area but also in an outdoor area. Furthermore, the track may be assembled in a module form, and may be easily reduced and extended. For example, when the size of an indoor area is limited, a user may reduce the track to fit the size of the indoor area and may then assemble the track. In contrast, when the size of an outdoor area is not limited, a user may maximally extend the track and may then assemble the track.

Although the 8-shaped track has been illustrated in FIG. 5a as an example, the present invention is not limited thereto. Accordingly, the locations at which the obstacles 511 to 518 and the guide bars 521 to 527 are arranged may be varied into a circular shape, an 8 shape, an S shape, a maze shape, or the like according to the setting of a user.

FIGS. 5b to 5f are views illustrating obstacles included in a track according to an embodiment of the present invention. As shown in FIGS. 5b to 5f, obstacles 530 have respective gates in set regions of the obstacles 530, thereby allowing the unmanned air vehicle to pass through them. Although the shapes of the gates are arcuate shape, a hexagonal shape, a rectangular shape, a circular shape, and a star shape in the present embodiment, the shapes of the gates are limited thereto. However, the gates may be fabricated in various shapes, such as a triangular shape, according to the setting of a user.

Furthermore, although the obstacles 530 are erected on the track, they are not limited thereto, but may float in the air in a portable form. Furthermore, the obstacles 530 may indicate the course of the unmanned air vehicle by the varying color of the obstacles 530. Furthermore, the obstacles 530 are provided with sensor units 540 in set regions of the obstacles 530, and thus detect the time information, speed information, direction information, and altitude information of the unmanned air vehicle that has passed through the gates. Although the obstacles 530 in which the sensor units 540 are provided along the edges of the gates have been described as an example in the present embodiment, they are not limited thereto, but the sensor units 540 may be provided in various regions, such as the upper side, lower side, left and right sides, etc. of the obstacles 530 according to the setting of a user.

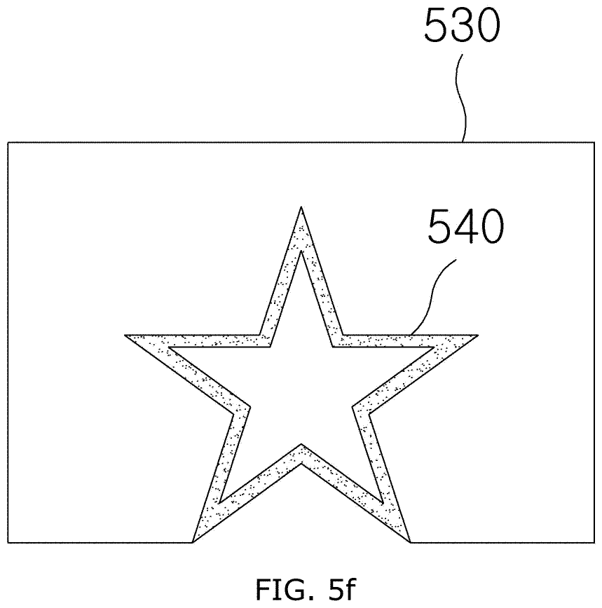

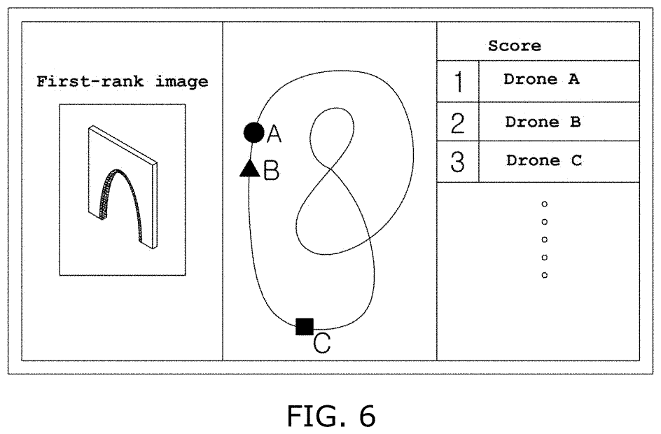

FIG. 6 is a view illustrating an image displayed on an electronic scoreboard according to an embodiment of the present invention. First, as shown in FIG. 6, the electronic scoreboard according to the embodiment of the present invention may display an image taken by the unmanned air vehicle, the location of the unmanned air vehicle on an overall race course, and the score and ranking of the unmanned air vehicle participating in the race in a set region of the electronic scoreboard.

For example, the electronic scoreboard may display an image taken by the unmanned air vehicle ranking first in a left region, may display the location of the unmanned air vehicle on an overall race course in a center region, and may display the current ranking of the unmanned air vehicle participating in the race in a left region.

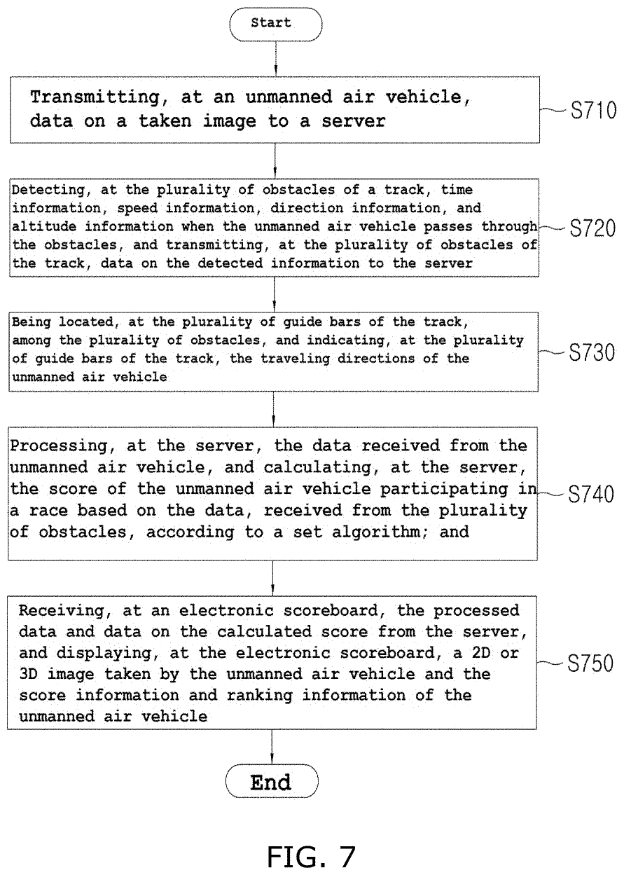

FIG. 7 is a flowchart illustrating an unmanned air vehicle racing method according to an embodiment of the present invention. First, as shown in FIG. 7, the unmanned air vehicle transmits data on an image, taken by the unmanned air vehicle, to the server at step S710.

Thereafter, at step S720, the plurality of obstacles detects time information, speed information, direction information, and altitude information when the unmanned air vehicle passes through the obstacles, and transmits data on the detected information to the server.

Thereafter, at step S730, the plurality of guide bars is located along the plurality of obstacles, and indicates the traveling directions of the unmanned air vehicle.

Thereafter, at step S740, the server processes the data received from the unmanned air vehicle, and calculates the score of the unmanned air vehicle participating in a race based on the data, received from the plurality of obstacles, according to the set algorithm.

Thereafter, at step S750, the electronic scoreboard receives the processed data and data on the calculated score from the server, and displays the 2D or 3D image, taken by the unmanned air vehicle, and the score information and ranking information of the unmanned air vehicle.

In the present specification, each block or each step may represent a module, segment, or portion of code that includes one or more executable instructions for implementing the specified logical function(s). It should also be noted that in some alternative implementations, the functions noted in the blocks or steps may occur in a different order. For example, two blocks or steps shown in succession may, in fact, be executed substantially concurrently or the blocks or steps may sometimes be executed in reverse order, depending upon the functionality involved.

The steps of a method or algorithm described in connection with the embodiments disclosed in the present specification may be embodied directly in hardware, in a software module executed by a processor, or in the combination of the two. The software module may reside in RAM memory, flash memory, ROM memory, EPROM memory, EEPROM memory, registers, a hard disk, a removable disk, CD-ROM, or any other form of storage medium known in the art. An exemplary storage medium is coupled to the processor such that the processor can read information from, and write information to, the storage medium. Otherwise, the storage medium may be integrated with the processor. The processor and the storage medium may reside in an application-specific integrated circuit (ASIC). The ASIC may reside in a user terminal. Otherwise, the processor and the storage medium may reside as discrete components in a user terminal.

While the present invention has been described in more detail with reference to the exemplary embodiments, the present invention is not limited to the exemplary embodiments, but may be modified and practiced in various manners without departing from the technical spirit of the invention. Accordingly, the embodiments disclosed in the present invention are used not to limit but to describe the technical spirit of the present invention, and the technical spirit of the present invention is not limited to the embodiments. Therefore, the embodiments described above are considered to be illustrative but not to be restrictive in all respects. The scope of protection of the present invention should be interpreted based on the attached claims and it should be interpreted that all technical spirits within a scope equivalent thereto are included in the scope of rights of the present invention.

1. An unmanned air vehicle racing system, comprising:
at least one unmanned air vehicle which transmits data on a taken image to a server;
a track which comprises:
a plurality of obstacles which detects time information, speed information, direction information, and altitude information when the unmanned air vehicle passes through the obstacles, and which transmits data on the detected information to the server; and
a plurality of guide bars which is located among the plurality of obstacles, and which indicates traveling directions of the unmanned air vehicle;
the server which processes the data received from the unmanned air vehicle, and which calculates a score of the unmanned air vehicle participating in a race based on the data, received from the plurality of obstacles, according to a set algorithm; and
an electronic scoreboard which receives the processed data and data on the calculated score from the server, and which displays a 2D or 3D image taken by the unmanned air vehicle and score information and ranking information of the unmanned air vehicle.

2. The unmanned air vehicle racing system of claim 1, wherein the track is a variable track in which a shape in which the plurality of obstacles and the plurality of guide bars are arranged is varied into a set shape.

3. The unmanned air vehicle racing system of claim 1, wherein each of the obstacles comprises:
a gate in which an entrance having a set shape through which the unmanned air vehicle can pass is formed;
a sensor unit which is provided in a set location, and which detects time information, speed information, direction information, and altitude information when the unmanned air vehicle passes through the gate;
a communication unit which transmits data on the information, detected by the sensor unit, to the server; and
a control unit which controls overall operation.

4. The unmanned air vehicle racing system of claim 1, wherein the server comprises:
a control unit which processes the data received from the unmanned air vehicle, and which calculates the score of the unmanned air vehicle participating in the race based on the data, received from the plurality of obstacles, according to the set algorithm; and
a communication unit which receives data on the taken image from the unmanned air vehicle, which transmits the processed data to the electronic scoreboard, which receives the data on the detected information from the obstacles, and which transmits the data on the calculated score to the electronic scoreboard.

5. An unmanned air vehicle racing method, comprising:
transmitting, at an unmanned air vehicle, data on a taken image to a server;
detecting, at a plurality of obstacles of a track, time information, speed information, direction information, and altitude information when the unmanned air vehicle passes through the obstacles, and transmitting, at the plurality of obstacles of the track, data on the detected information to the server;
being located, at a plurality of guide bars of the track, among the plurality of obstacles, and indicating, at the plurality of guide bars of the track, traveling directions of the unmanned air vehicle;
processing, at the server, the data received from the unmanned air vehicle, and calculating, at the server, a score of the unmanned air vehicle participating in a race based on the data, received from the plurality of obstacles, according to a set algorithm; and
receiving, at an electronic scoreboard, the processed data and data on the calculated score from the server, and displaying, at the electronic scoreboard, a 2D or 3D image taken by the unmanned air vehicle and score information and ranking information of the unmanned air vehicle.
